(19) United States
(12) Patent Application Publication
(10) Pub. No.: US 2020/0029381 A1
(43) Pub. Date: Jan. 23, 2020

(54) METHOD AND DEVICE FOR DETERMINING RADIO BEARER MODE

(71) Applicant: ZTE CORPORATION, Shenzhen, Guangdong (CN)

(72) Inventors: HAO WU, Shenzhen, Guangdong (CN); KUN YANG, Shenzhen, Guangdong (CN); JIANFENG DING, Shenzhen, Guangdong (CN); CHEN LU, Shenzhen, Guangdong (CN)

(21) Appl. No.: 16/495,183

(22) PCT Filed: Jan. 10, 2018
(86) PCT No.: PCT/CN2018/072030

§ 371 Date: Sep. 18, 2019

(30) Foreign Application Priority Data
Mar. 21, 2017 (CN) 201710170346.X

(51) Int. Cl. H04W 76/16; H04W 76/11

(52) U.S. Cl. CPC H04W 76/16; H04W 76/11

(57) ABSTRACT

The present disclosure relates to a method and a device for determining a radio bearer mode. The method includes: a terminal receiving bearer configuration information; and in the case where a bearer corresponding to a bearer identifier in the bearer configuration information has been established at the terminal and is an MWA bearer, and a bearer type indicated in the bearer configuration information is a dual-connection bearer, the terminal establishing or reconfiguring the dual-connection bearer according to the bearer configuration information. With the technical solutions provided by the present disclosure, scenario handover is performed on a terminal configured with an MWA technology, and a data transmitting and receiving mode of the terminal is switched, avoiding a situation in which the terminal is configured with two types of radio bearers, that is, both an MWA radio bearer and a dual-connectivity radio bearer, thereby reducing a processing complexity of data transmitting and receiving of the terminal, and also providing a more flexible data transmitting and receiving mode, and improving the efficiency of data transmitting and receiving of the terminal.

### FIELD OF THE INVENTION

The present disclosure relates to, but is not limited to, a method and device for determining a radio bearer mode.

### BACKGROUND

Nowadays, WLAN (Wireless Local Area Networks) and mobile communication technology have become two of the most successful wireless communication technologies and they have complemented with each other for a long time. On one hand, the biggest advantage of Wi-Fi technology of WLAN is that it runs on an unlicensed spectrum such that anyone can deploy a Wi-Fi network, and it can support almost any smart handheld devices or Internet of Things devices as desirable. Wi-Fi is more suitable for indoor applications with a large capacity, high density and low mobility. On the other hand, mobile communication technology has swept the world in the past few decades, creating a huge wireless wide area network, such as GSM (Global System for Mobile communication), WCDMA (Wideband Code Division Multiple Access), LTE (Long Term Evolution), 5G (5^{th} generation mobile communication technology) networks. The mobile communication technology has the advantages of ubiquitous outdoor coverage and seamless mobility, and more perfectly supports real-time applications such as voice and stream media. The combination of the WLAN and mobile communication technologies will bring great hope to the whole industry.

At present, 3GPP (3rd Generation Partnership Project) launched LWA (LTE-WLAN Aggregation) technology combining the LTE and WLAN. By means of LWA technology, payload of the mobile network data can be separated, such that some traffic is transmitted over WLAN, and the rest is transmitted through mobile network itself, thereby greatly improving the performance of mobile network service. FIG. 1 is an architecture diagram of an LWA in the related art. As shown in FIG. 1, a bearer of LWA technology includes a split bearer, such as a split LWA Bearer in FIG. 1, and a switched bearer, such as Switched LWA Bearer in FIG. 1. The split bearer indicates data are transmitted and received simultaneously on the LTE network and the WLAN network, and the switched bearer indicates that data is transmitted and received only in one of the LTE network and the WLAN network at the same time. For a detailed description of FIG. 1, reference may be made to related protocols, and details thereof will not be described herein.

At the same time, 3GPP has introduced a dual connectivity technology, such that the terminal can connect two base stations (including a primary base station and a secondary base station) for data transmission and reception at the same time to improve the transmission rate, wherein control signaling interaction and data transmission are performed between the primary base station and the terminal, only data transmission is performed between the secondary base station and the terminal. FIG. 2 is an architecture diagram of a dual connectivity technology in the related art. As shown in FIG. 2, the bearer of the dual connectivity technology includes three types of bearers: a separate bearer, such as Split Bearer in FIG. 2, which indicates that the primary base station (such as MeNB in FIG. 2) and the secondary base station (such as SeNB in FIG. 2) can simultaneously transmit and receive data; a primary base station bearer, such as MCG Bearer in FIG. 2, which indicates that only the primary base station can transmit and receive data; and a secondary base station bearer, such as SCG Bearer in FIG. 2, which indicates that only the secondary base station can transmit and receive data. For a detailed description of FIG. 2, reference may be made to related protocols, and details thereof will not be described herein.

### SUMMARY

In order to solve above technical problems, the present disclosure provides a method and device for determining a radio bearer mode, which can reduce processing complexity of data transmission and reception of a terminal.

In order to achieve the objectives of the present disclosure, the disclosure provides a method for determining a radio bearer mode, including: receiving, by a terminal, bearer configuration information; in the case where a bearer corresponding to a bearer identifier in the bearer configuration information is established in the terminal and is an MWA bearer, when a bearer type indicated in the bearer configuration information is a dual connectivity bearer, establishing or reconfiguring, by the terminal, the dual connectivity bearer according to the bearer configuration information, wherein the bearer identifier is used to uniquely identify the bearer and the bearer type is used to indicate the bearer that needs to be established or changed.

The disclosure further provides a device for determining a radio bearer mode, including: a receiving module and a processing module, wherein the receiving module is configured to receive bearer configuration information; and the processing module is configured to: in the case where the bearer corresponding to the bearer identifier in the bearer configuration information is established in the terminal and is the MWA bearer, when the bearer type indicated in the bearer configuration information is a dual connectivity bearer, establish or reconfigure the dual connectivity bearer according to the bearer configuration information, wherein the bearer identifier is used to uniquely identify a bearer; and the bearer type is used to indicate a bearer that needs to be established or changed.

The disclosure also provides a storage medium configured to store program code for performing any one of the above methods.

Compared with the related art, the technical solution of the present application at least includes: the terminal receives the bearer configuration information; if the bearer corresponding to the bearer identifier in the bearer configuration information is established in the terminal and is the MWA bearer, when a bearer type indicated in the bearer configuration information is a dual connectivity bearer, the terminal establishes or reconfigures the dual connectivity bearer according to the bearer configuration information. Through the technical schemes according to the present disclosure, the scenario handover is performed on the terminal configured with the MWA technology and the data transmission and reception mode of the terminal is switched, avoiding a situation where the terminal is configured with two types of radio bearers, i.e., an MWA radio bearer and a dual-connectivity radio bearer at the same time, thereby reducing a processing complexity of the data transmission and reception of the terminal, providing a more flexible data transmission and reception mode, and improving the efficiency of data transmission and reception of the terminal.

Other features and advantages of the present disclosure will be set forth in the description hereinafter and become apparent partially from the description or be understood by implementing the disclosure. The objectives and other advantages of the present disclosure can be realized and obtained by the structure particularly pointed out in the description, claims and accompanying drawings.

### BRIEF DESCRIPTION OF THE DRAWINGS

The drawings described herein are intended to provide a further understanding of the present disclosure, which forms a part of the present disclosure. The exemplary embodiments of the present disclosure and the explanation thereof are not intended to limit the disclosure. In the drawing:

FIG. 1 is an architectural diagram of an LWA in the related art;

FIG. 2 is an architectural diagram of a dual connectivity technology in the related art;

FIG. 3 is a flowchart of a method for determining a radio bearer mode according to an embodiment of the present disclosure;

FIG. 4 is a schematic block diagram of a device for determining a radio bearer mode according to an embodiment of the present disclosure.

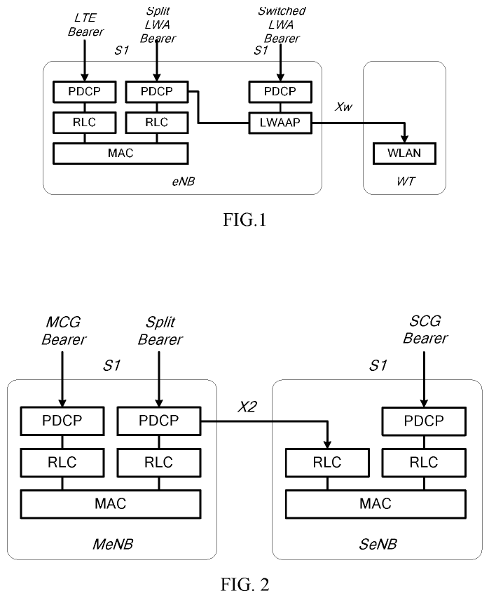

### DETAILED DESCRIPTION OF THE EMBODIMENTS

In order to better understand the objectives, technical schemes and advantages of the disclosure, the embodiments of the present disclosure will be described in detail below with reference to the accompanying drawings. It should be noted that, in the case of no conflict, the features in the embodiments and the embodiments in the present application may be arbitrarily combined with each other.

In the 5G system, in order to improve the user experience, data transmission and reception is required not to be interrupted when the terminal is switched, which is called 0 ms handover. In order to meet this requirement, in the related art, when the terminal is switched, the terminal is configured to use the dual connectivity technology and connect to a source base station and a target base station at the same time. After the handover is completed, the terminal returns to a single connection state via an indication from the base station.

If the terminal is configured to use the mobile network and WLAN aggregation technology, which is referred to as the Mobile WLAN Aggregation (MWA) technology in the present disclosure, before the handover, the terminal needs to be configured to use the dual-connectivity technology based on configuration information from the network side such as the base station when the terminal is switched according to the related art. That is to say, at this time, the terminal is simultaneously configured with two types of radio bearer which are a radio bearer of the MWA and a radio bearer of the dual-connection. In this way, the processing complexity of data transmission and reception of the terminal is undoubtedly greatly increased. Herein, the MWA technology is a generalized name of the above LWA, indicating that the aggregation with the WLAN is not limited to the LTE network, but also applied to mobile networks such as 5G network.

In addition, in the 5G network, in order to provide a more flexible data transmission and reception mode for the terminal, the terminal may be allowed to select a mode for transmitting and receiving data according to conditions such as the signal quality and coverage of the current mobile network, and the coverage of the WLAN access point deployed in the periphery. For example, in order to save mobile network resources, the dual connectivity mode is changed to the MWA mode. Or when excessive terminals access to the WLAN access point, the data transmission and reception rate may be significantly reduced to necessarily switch to a dual connectivity mode. That is to say, in these cases, the terminal also faces the problem of radio bearer establishment or reconfiguration. If the terminal has been configured to use the mobile network and WLAN aggregation technology, in the process of establishing or reconfiguring the radio bearer, the configuration of the MWA and the dual connection may also exist in the terminal, thereby increasing the processing complexity of the data transmission and reception of the terminal

FIG. 3 is a flowchart of a method for determining a radio bearer mode according to an embodiment of the present disclosure. As shown in FIG. 3, the method at least includes:

Step 300: the terminal receives bearer configuration information.

Optionally, the terminal may receive the bearer configuration information from the network side, such as the base station, when the terminal is switched or selects the mode of transmitting and receiving the data according to the conditions such as the signal quality and coverage of the current mobile network and the coverage of the WLAN access point deployed in the periphery. Here, the network side, such as the base station, may carry the bearer configuration information into radio resource connection configuration signaling and send it out to the terminal.

The bearer configuration information may include at least: a bearer identifier for uniquely identifying a bearer; and a bearer type for indicating a bearer to be established or changed.

Optionally, the bearer configuration information may further include: Packet Data Convergence Protocol (PDCP) configuration information, and/or Radio Link Control (RLC) protocol configuration information, and/or logical channel configuration information.

Optionally, the bearer configuration information may further include: first bearer information indicating whether to release, establish or reconfigure a first bearer.

In the embodiment of the present disclosure, the bearer is a logical entity for performing data transmission in the wireless communication. When there is a message to be transmitted between the network and the UE, the radio bearer needs to be first established, which is equivalent to a logical channel between the terminal and the base station.

Step 301: if the bearer corresponding to the bearer identifier in the bearer configuration information is established in the terminal and is the MWA bearer, when the bearer type indicated in the bearer configuration information is a dual connectivity bearer, the terminal establishes or reconfigures the dual connectivity bearer according to the bearer configuration information.

In this step, the terminal establishes or reconfigures the dual connectivity bearer according to the bearer configuration information, including:

the terminal establishes or reconfigures a local PDCP entity of the terminal according to PDCP configuration information, and/or

the terminal establishes or reconfigures a local RLC entity of the terminal according to RLC configuration information, and/or

the terminal establishes or reconfigures a local logical channel of the terminal according to logical channel configuration information.

The embodiment of the disclosure further include:

Step 302: the terminal closes a data processing function of an MWA bearer in an MWA application protocol entity.

Closing the processing function of the application protocol entity means that the data corresponding to the bearer is not processed and is transparently transmitted to the WLAN network, or after receiving the data corresponding to the bearer, an error indication is sent to the PDCP entity. For example, the data processing function of the radio bearer of the MWA in the LWAAP (LWA Access Point) entity in FIG. 1 is closed.

Through the method for determining the radio bearer mode according to the embodiment of the present disclosure, the scenario handover is performed on the terminal configured with the MWA technology and the data transmission and reception mode of the terminal is switched, avoiding a situation where the terminal is configured with two types of radio bearers, i.e., an MWA radio bearer and a dual-connectivity radio bearer at the same time, thereby reducing a processing complexity of the data transmission and reception of the terminal, providing a more flexible data transmission and reception mode, and improving the efficiency of data transmission and reception of the terminal.

The method for determining the radio bearer mode of the present disclosure will be described in detail below with reference to the embodiments.

In the first embodiment, it is assumed that a terminal has established a radio bearer of MWA, and bearer configuration information sent from a base station includes a bearer identifier, a bearer type, and secondary base station RLC configuration information.

When the terminal receives a radio resource connection configuration signaling sent from the base station, if the local bearer corresponding to the bearer identifier in the bearer configuration information carried therein is the MWA bearer, the bearer type is indicated as a split bearer, and secondary base station RLC configuration information which is a parameter required to establish or reconfigure an RLC entity in communication with the secondary base station is the secondary base station RLC configuration information, the terminal establishes the RLC entity that communicates with the secondary base station according to the secondary base station RLC configuration information in the bearer configuration information; and the data processing function of the MWA radio bearer in the MWA application protocol entity, such as the LWAAP entity in FIG. 1, is closed.

Optionally, the bearer configuration information sent from the base station may further include:

secondary base station logical channel configuration information, which is a parameter required to establish or reconfigure a logical channel that communicates with the secondary base station; and/or

PDCP configuration information, which is a parameter required to establish or reconfigure a PDCP entity; and/or

primary base station RLC configuration information, which is a parameter required to establish or reconfigure a RLC entity that communicates with the primary base station; and/or

primary base station logical channel configuration information, which is a parameter required to establish or reconfigure a logical channel that communicates with the primary base station.

Correspondingly, the embodiment further includes:

if the bearer configuration information includes the PDCP configuration information, the PDCP entity of the terminal is reconfigured according to the PDCP configuration information;

if the bearer configuration information includes the primary base station RLC configuration information, the RLC entity that communicates with the primary base station is reconfigured according to the RLC configuration information;

if the bearer configuration information includes the primary base station logical channel configuration information, the logical channel that communicates with the primary base station is reconfigured according to the primary base station logical channel configuration information; and

if the bearer configuration information includes the secondary base station logical channel configuration information, the logical channel that communicates with the secondary base station is established according to the secondary base station logical channel configuration information.

Possible operations of performing a PDCP data recovery process may include: sending PDCP data status from the terminal to the base station, wherein the PDCP status indicates the base station from which the data packet is successfully received or/and the serial number of lost data packet; and resending the data package that is not confirmedly received by the terminal from the base station.

In the second embodiment, it is assumed that the bearer configuration information sent from the base station includes a bearer identifier, a bearer type, secondary base station RLC configuration information, and secondary base station logical channel configuration information.

When the terminal receives a radio resource connection configuration signaling sent from the base station, if the local bearer corresponding to the bearer identifier in the bearer configuration information carried therein is a MWA bearer and the bearer type is a secondary cell group bearer, the terminal may reconfigure the RLC entity that the terminal communicates with the primary base station to be an RLC entity that communicates with the secondary base station, and reconfigure the logical channel that the terminal communicates with the primary base station to be a logical channel that communicates with the secondary base station; and the data processing function of the MWA radio bearer in the MWA application protocol entity, such as the LWAAP entity in FIG. 1, may be closed.

Optionally, the bearer configuration information sent from the base station may further include:

PDCP configuration information, which is a parameter required to establish or reconfigure a PDCP entity; and/or

secondary base station RLC configuration information, which is a parameter required to establish or reconfigure the RLC entity that communicates with the secondary base station; and/or

secondary base station logical channel configuration information, which is a parameter required to establish or reconfigure the logical channel that communicates with the secondary base station.

Correspondingly, the embodiment further includes:

if the bearer configuration information includes the PDCP configuration information, the PDCP entity of the terminal is reconfigured according to the PDCP configuration information;

if the bearer configuration information includes the secondary base station RLC configuration information, the RLC entity that communicates with the secondary base station is reconfigured according to the secondary base station RLC configuration information; and

if the bearer configuration information includes the secondary base station logical channel configuration information, the logical channel communicated with the secondary base station is reconfigured according to the secondary base station logical channel configuration information; and

a PDCP data recovery process is performed.

In the third embodiment, it is assumed that the bearer configuration information sent from the base station includes a bearer identifier, a bearer type, and WMA bearer information. Herein, the WMA bearer information is used to indicate whether to configure the WMA bearer. For example, when a value of the WMA bearer information is true (True), it is indicated that the WMA bearer needs to be established or reconfigured. As another example, when the value of the WMA bearer information is false (False), it is indicated to release the WMA bearer.

When the terminal receives a radio resource connection configuration signaling sent from the base station, if the local bearer corresponding to the bearer identifier in the bearer configuration information carried therein is the MWA bearer, the bearer type is a split bearer, the value of the WMA bearer information is False, and the parameter required to establish or reconfigure the RLC entity that communicates with the secondary base station is the secondary base station RLC configuration information, then the terminal may establish the RLC entity that communicates with the secondary base station according to the secondary base station RLC configuration information; and the data processing function of the MWA radio bearer in the MWA application protocol entity, such as the LWAAP entity in FIG. 1, may be closed.

Optionally, the bearer configuration information sent from the base station may further include:

secondary base station logical channel configuration information, which is a parameter required to establish or reconfigure a logical channel that communicates with the secondary base station; and/or

PDCP configuration information, which is a parameter required to establish or reconfigure a PDCP entity; and/or

primary base station RLC configuration information, which is a parameter required to establish or reconfigure an RLC entity that communicates with the primary base station; and/or

primary base station logical channel configuration information, which is a parameter required to establish or reconfigure a logical channel that communicates with the primary base station.

Correspondingly, the embodiment further includes:

if the bearer configuration information includes the PDCP configuration information, the PDCP entity of the terminal is reconfigured according to the PDCP configuration information;

if the bearer configuration information includes the primary base station RLC configuration information, the RLC entity that communicates with the primary base station is reconfigured according to the RLC configuration information;

if the bearer configuration information includes the primary base station logical channel configuration information, the logical channel that communicates with the primary base station is reconfigured according to the logical channel configuration information;

if the bearer configuration information includes the secondary base station logical channel configuration information, the logical channel that communicates with the secondary base station is established according to the secondary base station logical channel configuration information; and

a PDCP data recovery process is performed.

In the fourth embodiment, it is assumed that the bearer configuration information sent from the base station includes a bearer identifier, a bearer type, and includes WMA bearer information. Herein, the WMA bearer information is used to indicate whether to configure the WMA bearer. For example, when the value of the WMA bearer information is true (True), it is indicated that the WMA bearer needs to be established or reconfigured. As another example, when the value of the WMA bearer information is false (False), it is indicated to release the WMA bearer.

When the terminal receives a radio resource connection configuration signaling sent from the base station, if the local bearer corresponding to the bearer identifier in the bearer configuration information carried therein is an MWA bearer, the bearer type is a secondary cell group bearer, and the value of the WMA bearer information is False, then the terminal may reconfigure the RLC entity that the terminal communicates with the primary base station to be an RLC entity that communicates with the secondary base station and reconfigure the logical channel that terminal communicates with the primary base station to be a logical channel that communicates with the secondary base station; and the data processing function of the MWA radio bearer in the MWA application protocol entity, such as the LWAAP entity in FIG. 1, may be closed.

Optionally, the bearer configuration information sent from the base station may further include:

PDCP configuration information, which is a parameter required to establish or reconfigure a PDCP entity; and/or

secondary base station RLC configuration information, which is a parameter required to establish or reconfigure the RLC entity that communicates with the secondary base station; and/or

secondary base station logical channel configuration information, which is a parameter required to establish or reconfigure a logical channel that communicates with the secondary base station.

Correspondingly, the embodiment further includes:

if the bearer configuration information includes the PDCP configuration information, the PDCP entity of the terminal is reconfigured according to the PDCP configuration information;

if the bearer configuration information includes the secondary base station RLC configuration information, the RLC entity that communicates with the secondary base station is reconfigured according to the secondary base station RLC configuration information; and

if the bearer configuration information includes the secondary base station logical channel configuration information, the logical channel communicated with the secondary base station is reconfigured according to the secondary base station logical channel configuration information; and

a PDCP data recovery process is performed.

The present disclosure also provides a computer readable storage medium, storing computer executable instructions for performing the method of determining the radio bearer mode according to any one aspect of the present disclosure.

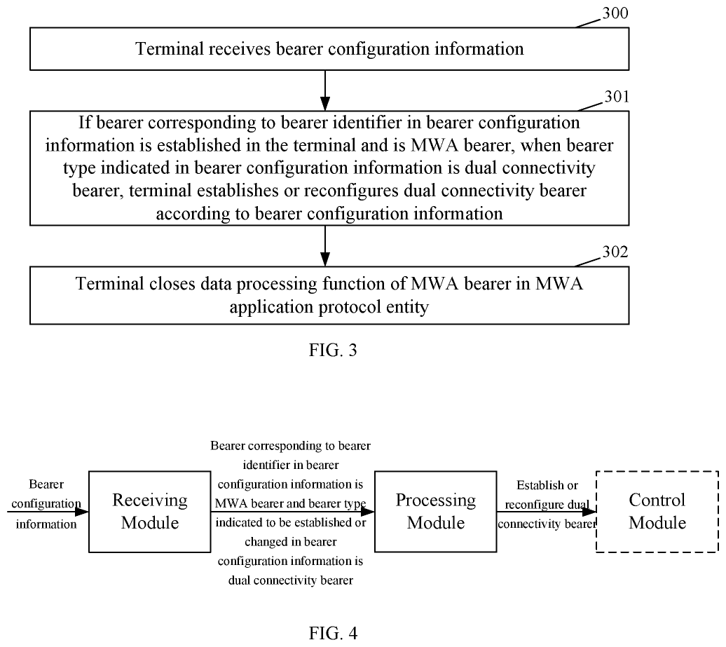

FIG. 4 is a schematic block diagram of a device for determining a radio bearer mode according to an embodiment of the present disclosure. As shown in FIG. 4, the device includes at least: a receiving module and a processing module, wherein

the receiving module is configured to receive bearer configuration information; and

the processing module is configured to: in the case where the bearer corresponding to the bearer identifier in the bearer configuration information is established in the terminal and is the MWA bearer, when the bearer type indicated in the bearer configuration information is a dual connectivity bearer, establish or reconfigure the dual connectivity bearer according to the bearer configuration information.

The bearer identifier is used to uniquely identify a bearer; and the bearer type is used to indicate a bearer that needs to be established or changed.

The device for determining the radio bearer mode in the embodiment of the disclosure further includes:

a control module configured to: close a data processing function of the MWA bearer in the MWA application protocol entity, and/or perform a PDCP data recovery process.

Optionally, the bearer configuration information may further include: PDCP configuration information, and/or RLC protocol configuration information, and/or logical channel configuration information.

Optionally, the bearer configuration information may further include: WMA bearer information indicating whether to release, establish or reconfigure the WMA bearer. Correspondingly, the processing module is further configured to: determine the first bearer information in the bearer configuration information indicating to release the first bearer.

Optionally, the processing module is configured to: establish or reconfigure a local PDCP entity of the terminal according to the PDCP configuration information, and/or establish or reconfigure a local RLC entity of the terminal according to the RLC configuration information, and/or establish or reconfigure a local logical channel of the terminal according to the logical channel configuration information.

The device for determining the radio bearer mode according to the embodiment of the present disclosure may be disposed in the terminal, or may be an independent entity.

The above description is only preferred embodiments of the present disclosure, and is not intended to limit the scope of the disclosure. Any modifications, equivalent substitutions and improvements made within the spirit and scope of the present disclosure are constructed to fall within the scope of the present disclosure.

### INDUSTRIAL APPLICABILITY

Through the technical schemes according to the present disclosure, the scenario handover is performed on the terminal configured with the MWA technology and the data transmission and reception mode of the terminal is switched, avoiding a situation where the terminal is configured with two types of radio bearers, i.e., an MWA radio bearer and a dual-connectivity radio bearer at the same time, thereby reducing a processing complexity of the data transmission and reception of the terminal, providing a more flexible data transmission and reception mode, and improving the efficiency of data transmission and reception of the terminal.

1-16. (canceled)

17. A method for determining a radio bearer, comprising:
receiving, by a terminal, bearer configuration information;
in the case where a bearer corresponding to a bearer identifier in the bearer configuration information is established in the terminal and is an MWA bearer, when a bearer type indicated in the bearer configuration information is a dual connectivity bearer, establishing or reconfiguring, by the terminal, the dual connectivity bearer according to the bearer configuration information, wherein
the bearer identifier is used to uniquely identify the bearer; and the bearer type is used to indicate the bearer that needs to be established or changed.

18. The method of claim 17, wherein the bearer configuration information further comprises: MWA bearer information indicating whether to release, establish or reconfigure an MWA bearer.

19. The method according to claim 17, wherein the bearer configuration information further comprises: Packet Data Convergence Protocol PDCP configuration information, and/or Radio Link Control RLC protocol configuration information, and/or logical channel configuration information.

20. The method of claim 18, wherein before establishing or reconfiguring, by the terminal, the dual connectivity bearer according to the bearer configuration information, the method further comprises:
the MWA bearer information in the bearer configuration information indicating to release the MWA bearer.

21. The method according to claim 17, wherein the step of establishing or reconfiguring, by the terminal, the dual connectivity bearer according to the bearer configuration information comprises:
establishing or reconfiguring, by the terminal, a local PDCP entity of the terminal according to PDCP configuration information; and/or
establishing or reconfiguring, by the terminal, a local RLC entity of the terminal according to RLC configuration information; and/or
establishing or reconfiguring, by the terminal, a local logical channel of the terminal according to logical channel configuration information.

22. The method according to claim 20, wherein the step of establishing or reconfiguring, by the terminal, the dual connectivity bearer according to the bearer configuration information comprises:
establishing or reconfiguring, by the terminal, a local PDCP entity of the terminal according to PDCP configuration information; and/or
establishing or reconfiguring, by the terminal, a local RLC entity of the terminal according to RLC configuration information; and/or
establishing or reconfiguring, by the terminal, a local logical channel of the terminal according to logical channel configuration information.

23. The method of claim 17, wherein the method further comprises:
closing, by, the terminal, a data processing function of the MWA bearer in the MWA application protocol entity, and/or
performing a PDCP data recovery process.

24. The method of claim 20, wherein the method further comprises:
closing, by, the terminal, a data processing function of the MWA bearer in the MWA application protocol entity, and/or
performing a PDCP data recovery process.

25. The method of claim 17, wherein the dual connectivity bearer is a split bearer and the bearer configuration information further comprises:
secondary base station RLC configuration information;
the step of establishing or reconfiguring, by the terminal, the dual connectivity bearer according to the bearer configuration information comprises:
establishing or reconfiguring, by the terminal, an RLC entity that communicates with a secondary base station according to the secondary base station RLC configuration information.

26. The method of claim 25, wherein the bearer configuration information further comprises:
secondary base station logical channel configuration information, which is a parameter required to establish or reconfigure a logical channel that communicates with the secondary base station; and/or
PDCP configuration information, which is a parameter required to establish or reconfigure a PDCP entity; and/or
primary base station RLC configuration information, which is a parameter required to establish or reconfigure a RLC entity that communicates with the primary base station; and/or
primary base station logical channel configuration information, which is a parameter required to establish or reconfigure a logical channel that communicates with the primary base station,
the method further comprises:
in the case where the bearer configuration information includes the PDCP configuration information, reconfiguring, by the terminal, the PDCP entity of the terminal according to the PDCP configuration information;
in the case where the bearer configuration information includes the primary base station RLC configuration information, reconfiguring, by the terminal, the RLC entity that communicates with the primary base station according to the RLC configuration information;
in the case where the bearer configuration information includes the primary base station logical channel configuration information, reconfiguring, by the terminal, the logical channel that communicates with the primary base station according to the primary base station logical channel configuration information; and
in the case where the bearer configuration information includes the secondary base station logical channel configuration information, establishing, by the terminal, the logical channel that communicates with the secondary base station according to the secondary base station logical channel configuration information.

27. The method according to claim 17, wherein the dual connectivity bearer is a secondary cell group bearer; the bearer configuration information further includes: secondary base station RLC configuration information and secondary base station logical channel configuration information;
the step of establishing or reconfiguring, by the terminal, the dual connectivity bearer according to the bearer configuration information comprises:
reconfiguring, by the terminal, the RLC entity that the terminal communicates with the primary base station to be an RLC entity that communicates with the secondary base station, and reconfiguring the logical channel that the terminal communicates with the primary base station to be a logical channel that communicates with the secondary base station.

28. The method of claim 27, wherein the bearer configuration information further comprises:
PDCP configuration information, which is a parameter required to establish or reconfigure a PDCP entity; and/or
secondary base station RLC configuration information, which is a parameter required to establish or reconfigure the RLC entity that communicates with the secondary base station; and/or
secondary base station logical channel configuration information, which is a parameter required to establish or reconfigure the logical channel that communicates with the secondary base station,
the method further includes:
in the case where the bearer configuration information includes the PDCP configuration information, reconfiguring, by the terminal, the PDCP entity of the terminal according to the PDCP configuration information;
in the case where the bearer configuration information includes the secondary base station RLC configuration information, reconfiguring, by the terminal, the RLC entity that communicates with the secondary base station according to the secondary base station RLC configuration information; and
in the case where the bearer configuration information includes the secondary base station logical channel configuration information, reconfiguring, by the terminal, the logical channel communicated with the secondary base station according to the secondary base station logical channel configuration information.

29. A device for determining a radio bearer mode, comprising: a receiving module and a processing module, wherein
the receiving module is configured to receive bearer configuration information; and
the processing module is configured to: in the case where the bearer corresponding to the bearer identifier in the bearer configuration information is established in the terminal and is the MWA bearer, when the bearer type indicated in the bearer configuration information is a dual connectivity bearer, establish or reconfigure the dual connectivity bearer according to the bearer configuration information, wherein
the bearer identifier is used to uniquely identify a bearer; and the bearer type is used to indicate a bearer that needs to be established or changed.

30. The device of claim 29, further comprising: a control module configured to close a data processing function of the MWA bearer in the MWA application protocol entity, and/or perform a PDCP data recovery process.

31. The device according to claim 29, wherein the bearer configuration information further includes: WMA bearer information indicating whether to release, establish or reconfigure the WMA bearer, and
the processing module is further configured to: determine the WMA bearer information indicating to release the first bearer.

32. The apparatus of claim 29, wherein the bearer configuration information further comprises: PDCP configuration information, and/or RLC protocol configuration information, and/or logical channel configuration information.

33. The apparatus of claim 29, wherein the processing module is configured to: establish or reconfigure a local PDCP entity of the terminal according to the PDCP configuration information, and/or
establish or reconfigure a local RLC entity of the terminal according to the RLC configuration information, and/or
establish or reconfigure a local logical channel of the terminal according to the logical channel configuration information.

34. A storage medium configured to store program code, wherein when executed by a processor, the program code performs a method for determining a radio bearer, comprising:
receiving, by a terminal, bearer configuration information;
in the case where a bearer corresponding to a bearer identifier in the bearer configuration information is established in the terminal and is an MWA bearer, when a bearer type indicated in the bearer configuration information is a dual connectivity bearer, establishing or reconfiguring, by the terminal, the dual connectivity bearer according to the bearer configuration information, wherein the bearer identifier is used to uniquely identify the bearer; and the bearer type is used to indicate the bearer that needs to be established or changed.
